(19) United States
(12) Patent Application Publication
(10) Pub. No.: US 2012/0198686 A1
(43) Pub. Date: Aug. 9, 2012

(54) LIQUID CARTRIDGE AND METHOD OF PRODUCING LIQUID CARTRIDGE

(75) Inventors: Takatoshi Kitagawa, Kawasaki-shi (JP); Yasuo Kotaki, Yokohama-shi (JP); Hitoshi Takada, Yokohama-shi (JP); Koichi Kubo, Yokohama-shi (JP); Hiroki Hayashi, Kawasaki-shi (JP); Takeho Miyashita, Kawasaki-shi (JP)

(73) Assignee: CANON KABUSHIKI KAISHA, Tokyo (JP)

(21) Appl. No.: 13/362,441

(22) Filed: Jan. 31, 2012

(30) Foreign Application Priority Data
Feb. 3, 2011 (JP) 2011-021782

(51) Int. Cl. B23P 17/04

(52) U.S. Cl. 29/592

(57) ABSTRACT

A method of producing a liquid cartridge having an identification part corresponding to a type of liquid held inside the liquid cartridge, the method includes preparing the liquid cartridge having a plurality of protrusions protruding from an external wall; and forming the identification part corresponding to the type of liquid by melting at least one of the protrusions. In this way, a strong mis-loading prevention part that prevents mis-loading of the liquid cartridge into a liquid consuming apparatus can be constituted without generating waste.

### BACKGROUND OF THE INVENTION

1. Field of the Invention

The present invention relates to a replaceable liquid cartridge for a liquid consuming apparatus and a method of producing a liquid cartridge.

2. Description of the Related Art

An inkjet recording apparatus, which is a liquid consuming apparatus, carries out recording by discharging liquid, such as ink, onto a recording medium. Some inkjet recording apparatuses have replaceable ink cartridges, which hold the ink to be discharged. Usually, a plurality of ink cartridges can be loaded into an ink jet recording apparatus so that different types of ink can be used.

Some inkjet recording apparatuses in which replaceable ink cartridges are loaded have a configuration for preventing mis-loading of an ink cartridge to avoid mixing of ink colors. In this way, the ink cartridges can be loaded into appropriate locations corresponding to the types of ink in the inkjet recording apparatus.

Japanese Patent Laid-Open No. 2004-009687 describes engagement parts, which are unique to the types of ink held in ink cartridges and provided on an external casing of the ink cartridge. When an ink cartridge holding a type of ink that differs from the assigned type of ink is to be loaded into a predetermined part of an inkjet recording apparatus, the engagement part disposed on the inkjet recording apparatus comes into contact with the engagement part on the ink cartridge, preventing the ink cartridge from being loaded. In this way, mis-loading of the ink cartridge is prevented.

FIG. 11 is a schematic view of an ink cartridge described in Japanese Patent Laid-Open No. 2004-009687. An ink cartridge 100 has an external casing 600, which has an ink supply port 700 through which ink is guided. An plurality of engagement parts 620 (five in FIG. 11) for preventing mis-loading is provided on the ink cartridge, and then specific engagement parts 620 are removed in accordance with the type of ink. The engagement parts on the inkjet recording apparatus protrude only from positions corresponding to positions 630 where engagement parts 620 were disposed before removing from the ink cartridge holding the corresponding type of ink. Hence, when an ink cartridge holding a differ type of ink is to be loaded, the engagement parts on the recording apparatus and the engagement parts 620 on the ink cartridge come into contact with each other, preventing mis-loading. With this configuration, only one type of mold is required for the external casing 600 of the ink cartridge and the accommodating part of the recording apparatus accommodating the ink cartridge, and thus, costs are reduced.

Japanese Patent Laid-Open No. 2004-009687 does not describe a specific method of removing the engagement parts of the ink cartridge. The engagement parts may be removed by cutting. In such a case, the cut engagement parts are discarded as waste. If such waste gets caught in the cutting device for cutting the engagement parts, the efficiency of the cutting device may be reduced.

Cutting may apply mechanical stress to the engagement parts and the periphery; in some cases, deformation and/or cracks may form in the area near the removed engagement parts, reducing the mechanical strength of the external casing of the ink cartridge. In particular, if the strength at the peripheries of the engagement parts for preventing mis-loading is reduced, the engagement parts will be damaged when an ink cartridge is to be loaded into a wrong position and will not function as a stopper, causing mis-loading and mixing of ink colors.

### SUMMARY OF THE INVENTION

One of the aspects of the present invention provides a liquid container and a method of producing a liquid container that can form of a strong mis-loading prevention part on an external wall of a cartridge holding a liquid while preventing waste generation in the production process described above.

Another aspects of the present invention provides a method of producing a liquid cartridge having an identification part corresponding to a type of liquid held inside the liquid cartridge, the method including preparing the liquid cartridge having a plurality of protrusions protruding from an external wall; and forming the identification part corresponding to the type of liquid by melting at least one of the protrusions.

According to an embodiment of the present disclosure, waste may not be generated because a mis-loading prevention part is formed through thermal processing. Since mechanical stress is not applied to the mis-loading prevention part during thermal processing, a reduction in the strength of the periphery of the mis-loading prevention part may be suppressed.

Further features of the present invention will become apparent from the following description of exemplary embodiments with reference to the attached drawings.

### BRIEF DESCRIPTION OF THE DRAWINGS

FIG. 1A is a perspective view of an ink cartridge before a thermal processing step in a first embodiment.

FIG. 1B is a front view the ink cartridge before the thermal processing step in the first embodiment.

FIG. 2A is a perspective view of the ink cartridge after the thermal processing step in the first embodiment.

FIG. 2B is a front view of the ink cartridge after the thermal processing step in the first embodiment.

FIG. 3 is a perspective view of the thermal processing step in the first embodiment.

FIG. 4 illustrates the mismatching of a mis-loading prevention part of the ink cartridge after performing the thermal processing step in the first embodiment and an identification part on a printer.

FIG. 5A is an enlarged sectional view taken along line VA-VA in FIG. 3 during thermal processing.

FIG. 5B is an enlarged view of a processed part after the thermal processing step.

FIG. 6A is a perspective view of an ink cartridge before a thermal processing step in a second embodiment.

FIG. 6B is a front view of the ink cartridge before the thermal processing step in the second embodiment.

FIG. 7A is a perspective view of the ink cartridge after the thermal processing step in the second embodiment.

FIG. 7B is a front view of the ink cartridge after the thermal processing step in the second embodiment.

FIG. 8 is a perspective view of the thermal processing step in the second embodiment.

FIG. 9 illustrates the mismatching of a mis-loading prevention part of the ink cartridge after the thermal processing step in the second embodiment and an identification part on a printer.

FIG. 10A illustrates the thermal processing step in the second embodiment.

FIG. 10B is an enlarged view of a processed part after the thermal processing step illustrated in FIG. 10A.

FIG. 11 is a schematic view of an ink cartridge described in Japanese Patent Laid-Open No. 2004-009687.

### DESCRIPTION OF THE EMBODIMENTS

Embodiments of the present invention will be described below with reference to the drawings. In the following, a replaceable ink cartridge that can be loaded into a printer, which is a liquid consuming apparatus, will be described as an example. The present invention, however, is not limited thereto and can be applied to any replaceable ink cartridge that holds a liquid and can be loaded into any liquid consuming apparatus that consumes the liquid. Such liquid consuming apparatuses may include a liquid discharging apparatus, such as an inkjet recording apparatus.

### First Embodiment

A method of producing an ink cartridge according to this embodiment includes a step of preparing the liquid cartridge having a plurality of protrusions protruding from an external wall (one of the examples of first step); and a thermal processing step of forming the identification part corresponding to the type of liquid by melting at least one of the protrusions (one of the examples of second step). Mis-loading into the printer refer to an attempt of loading an ink cartridge holding a particular type of ink into an attachment part of a printer, which is to process a type of ink different from the particular type of ink.

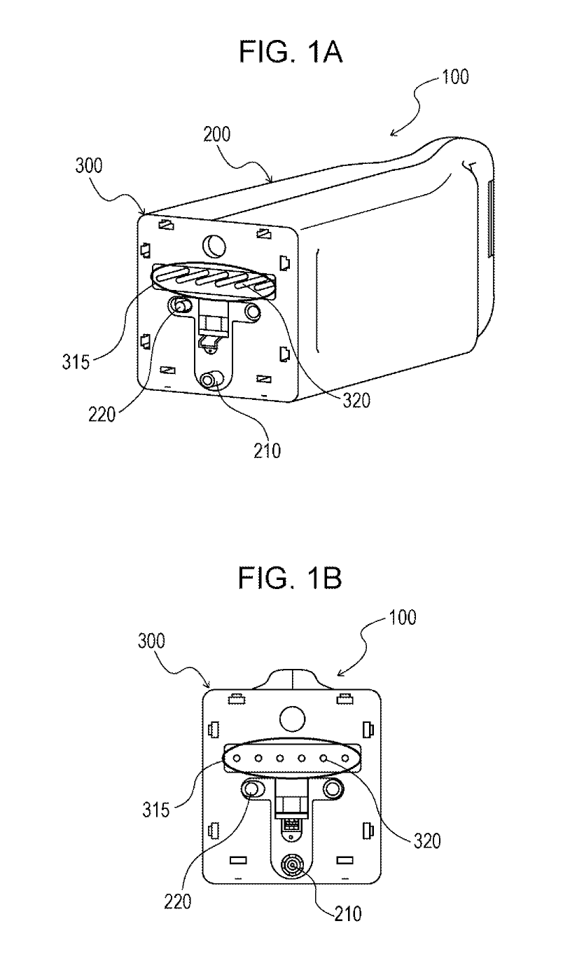

FIGS. 1A and 1B are respectively a perspective view and a front view of an ink cartridge 100 before the thermal processing step in the first embodiment. The ink cartridge 100 includes a liquid container 200, which holds ink, and a covering member 300. The liquid container 200 has a supply port 210 through which ink is guided and an alignment part 220, which aligns the supply port 210 and a needle (not shown) on the printer side. In this embodiment, the supply port 210 and the alignment part 220 are disposed on the front side of the printer in the loading direction of the ink cartridge 100, i.e., the side illustrated in FIG. 1B. A region 315, which serves as a mis-loading prevention part for preventing mis-loading of the ink cartridge 100 into a wrong part of the printer, is provided on the front side, in the loading direction, of the external wall of the covering member 300. In the example illustrated in FIGS. 1A and 1B, six columnar identification pins 320, which protrude from the external wall of the covering member 300, are provide in the region 315. In the first embodiment, it is desirable that each identification pin 320 is a column. The number of the identification pins 320 may be appropriately changed, and the shape of the identification pins 320 is not limited to that described above and may be modified. The ink cartridge 100 can be prepared through injection molding or blow molding using a mold. In such a case, it is desirable to make the ink cartridge 100 with thermoplastic resin.

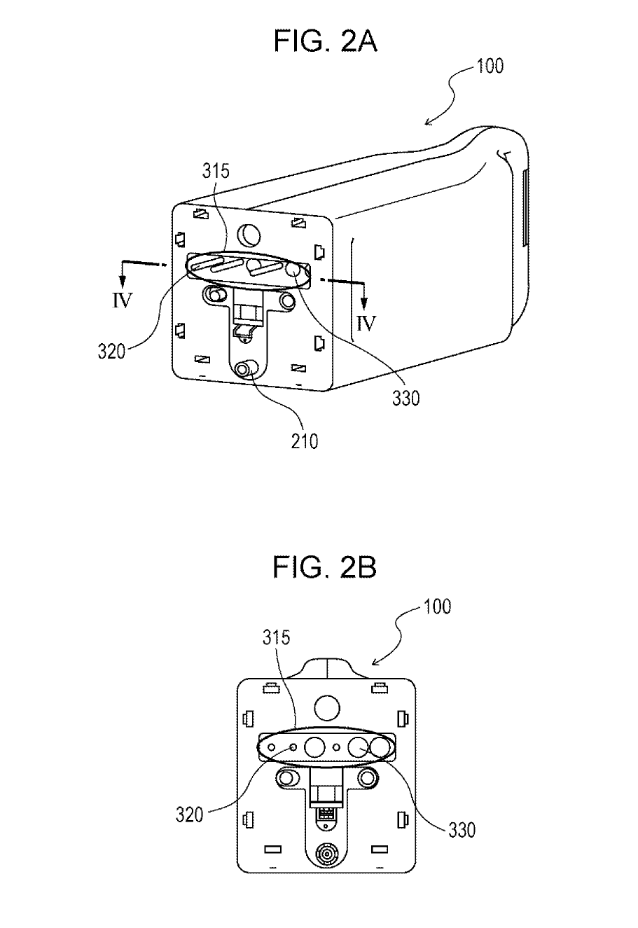

FIGS. 2A and 2B are respectively a perspective view and a front view of the ink cartridge 100 after the thermal processing step. In the thermal processing step, the identification pins 320 illustrated in FIGS. 1A and 1B, are thermally melted, except for at least one of the identification pins 320, to form the mis-loading prevention part 315. Since some of the identification pins 320 are crushed in the thermal processing step, the mis-loading prevention part 315 includes at least one identification pins 320 and processed parts 330, which are crushed by thermal processing. In the example illustrated in FIG. 2B, the processed parts 330 are formed by crushing the third, fifth, and six identification pins from the left in the drawing by thermal processing. The processed parts 330 include crushed identification pins 320 with reduced heights and enlarged diameters integrate with the external wall of the ink cartridge 100. The identification pins 320 in the first embodiment are heated, melted, and crushed. In consideration of the processing time and processability in the thermal processing step, it is desirable that the shape of each identification pin 320 is a hollow column. In another embodiment, each identification pin 320 may be a solid column. The shape of the identification pin 320, however, is not limited thereto and may be many different shapes, such as cones and square pillars.

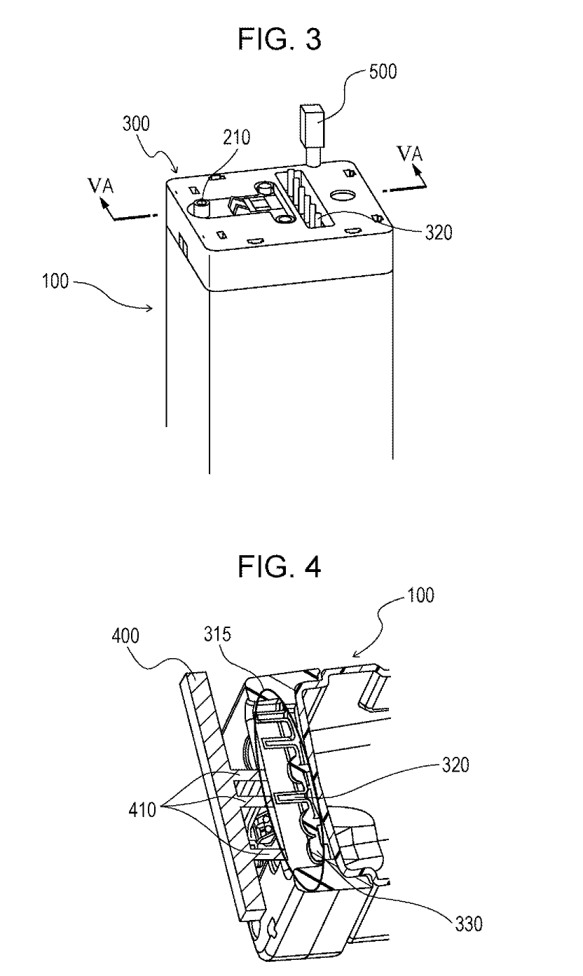

FIG. 3 illustrates the thermal processing in the first embodiment. It is desirable that the ink cartridge 100 is made of thermoplastic resin, such as polyethylene or polypropylene, which has a low melting point and can be thermally processed easily. It is desirable that the covering member 300 in the first embodiment is a member that protects the supply port 210 of the ink cartridge 100 from impact resulting from, for example, a fall. Thus, it is even more desirable that the covering member 300 is made of acrylonitrile butadiene styrene copolymerized resin (ABS resin), which has high impact resistance.

In the first embodiment, each identification pin 320, for example, is a hollow column with a height of 13.5 mm, a diameter of 5 mm, and a thickness of 0.7 mm. If a solid column is used, a large amount of resin will melt out during the thermal processing, causing the resin to overflow at the tip of a processing horn 500 and form burrs, which may interfere with the attachment part of the printer. Hence, it is desirable to use hollow projecting pins because projection pins can be formed without applying mechanical stress to the printer during thermal processing. Such thermal processing can be carried out by a thermal welding device (impulse welder), which is thermal processing unit. The processing horn 500 of the thermal welder may be formed with a diameter of 8 mm and a depression in the processing surface with a depth of 1.6 mm. It is desirable that the processing horn 500 applies heat while pressing an identification pin 320 from the tip toward the external wall of the ink cartridge 100.

As an example, the thermal processing conditions were set as follows: heating and pressing for 10.3 seconds at a processing temperature of 360° C. and a pressing load of 78.4 N and then cooling for 8 seconds. In this way, an identification pin 320 can be crushed in a total of approximately 20 seconds. It is desirable that a plurality of identification pins 320 is disposed vertically with respect to the horizontal surface (in the gravity direction) and each of the identification pins 320 is pressed with the processing horn 500 from the tip of the identification pin 320 toward the external wall of the ink cartridge 100. In this way, since the processed parts 330 melts during thermal processing and spreads uniformly to the surroundings, it is advantageous in that the strength of the processed part 330 on the external wall of the ink cartridge 100 increases. When the processing horn 500 is to be pressed against an identification pin 320 in the horizontal direction or from below in the gravity direction, the part melted during thermal processing will run unevenly and overflow at the tip of the processing horn 500, forming burrs, which may interfere with the attachment part of the printer. As described above, the mis-loading prevention part 315 can be formed through thermal processing without producing waste. With thermal processing, since mechanical stress is not applied to the processed parts 330, a reduction in strength of the processed parts 330 can be suppressed. In some cases, the processed parts 330 increase the thickness of the external wall of the ink cartridge 100, and, as a result, increase the strength of the external wall of the ink cartridge 100.

FIG. 4 is an enlarged sectional view taken along line VI-VI in FIG. 2A and illustrates mis-loading of the ink cartridge 100 into the printer after the thermal processing step in the first embodiment. The printer usually has a plurality of attachment parts where different types of ink cartridges are loaded. Each attachment part has identification parts 410, which are shaped to selectively allow loading of a cartridge holding a specific type of ink. In the example in FIG. 4, pins, which server as the identification parts 410, are provided on a frame 400 of the printer. The arrangement of the pins is uniquely set for each type of ink held in the ink cartridge that is to be loaded.

FIG. 4 illustrates mis-loading, and the ink cartridge 100 cannot be loaded into the printer because the identification pins 320, which are provided on the mis-loading prevention part 315 of the ink cartridge 100, contact the identification parts 410 on the printer. The identification parts 410 on the printer are formed in accordance with the type (color) of the ink held in the ink cartridge 100 to be loaded. Therefore, the identification parts 410 on the printer and the identification pins 320 of the mis-loading prevention part 315 do not match. The identification parts 410 and the identification pins 320 collide with each other, preventing mis-loading. Such collision prevents a joint part (not shown) of the printer from being inserted into the supply port 210 of the ink cartridge 100 and prevents mixing of ink colors.

When the ink cartridge 100 is loaded into a predetermined attachment part of the printer, the mis-loading prevention part 315 of the ink cartridge 100 and the identification parts 410 of the printer match, enabling the ink cartridge 100 to be loaded into the printer. Specifically, in the mis-loading prevention part 315 of the ink cartridge 100, the processed parts 330 are provided in positions corresponds to the positions of the pins, which serve as the identification parts 410, and the identification pins 320 are provided in positions where the pins, which serve as the identification parts 410, are not provided. In the thermal processing step, predetermined identification pins 320 are processed such that the mis-loading prevention part 315 functions in this way.

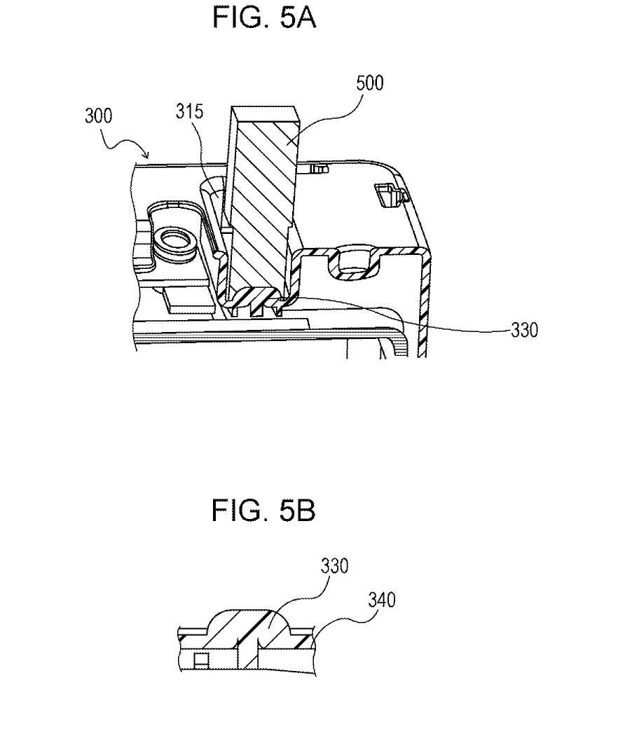

FIG. 5A is an enlarged sectional view taken along line VA-VA in FIG. 3 and illustrates the thermal processing step in the first embodiment. In FIG. 5A, an identification pin 320 is melt and deformed by the processing horn 500 to form a processed part 330 of the mis-loading prevention part 315.

FIG. 5B is an enlarged view of the processed part 330 illustrated in FIG. 5A after thermal processing. The external wall of the ink cartridge 100 corresponding to the processed part 330 is thickened by the thermal processing.

When the identification pin 320 is a column, the processed part 330 melted by the thermal processing, which is illustrated in FIG. 5B, has a thickened part as a result of it integrating with the external wall of the covering member 300, or more specifically, the bottom surface 340 of the mis-loading prevention part 315. When the ink cartridge 100 is mis-loaded, the impact of the collision at the identification pins 320 will be received by the bottom surface 340 of the mis-loading prevention part 315. Since the thickened processed parts 330 increases the strength of the bottom surface 340 near the identification pins 320, deformation and damage of the bottom surface 340 can be reduced even when impact is applied during mis-loading.

In the thermal processing method according to the first embodiment, it is desirable that the processing horn 500 is vertically pressed against the tip of an identification pin 320, as illustrated in FIG. 3. In this way, the pitch (distance between centers of adjacent pins) of the identification pins 320 in the region corresponding to the mis-loading prevention part 315 may be approximately the same as the diameter of the processing horn 500. Consequently, the area required for arranging the identification pins 320 is reduced.

In contrast, when identification pins are removed by cutting, a certain area is required around each identification pin because a cutting device for cutting the identification pins must be inserted to the bases of the pins. Thus, the area required for arranging the identification pins increases. Consequently, the size of the individual identification pins must be reduced to reduce the area required for arranging the identification pins, and, as a result, the strength of the mis-loading prevention part is reduced. Thus, when cutting is employed, it is difficult to constitute the mis-loading prevention part in a small area.

In this embodiment, the identification pins 320 can be arranged highly densely because the identification pins 320 are thermally processed. In this way, a strong mis-loading prevention part 315 can be provided in a small area.

In the first step of this embodiment, a plurality of identification pins 320 is formed in the same way on every ink cartridge 100, which may be holding different colors of ink; then, in the thermal processing step, the identification pins 320 are thermally processed such that ink cartridges 100 holding the same color of ink have the same mis-loading prevention part 315. In this way, only one type of mold for injection molding or blow molding will be needed to form the basic shape of the ink cartridges 100 in the first step. Therefore, the costs required for preparing the mold can be reduced.

### Second Embodiment

This embodiment provides a method of producing a liquid cartridge having an identification part for selectively loading the liquid cartridge in accordance with a type of liquid held inside the liquid cartridge, the method including preparing the liquid cartridge having a flat external wall for constituting the identification part (first step); and thermal processing step of forming the identification part corresponding to the type of liquid by forming at least one hole in the external wall by melting the external wall (second step).

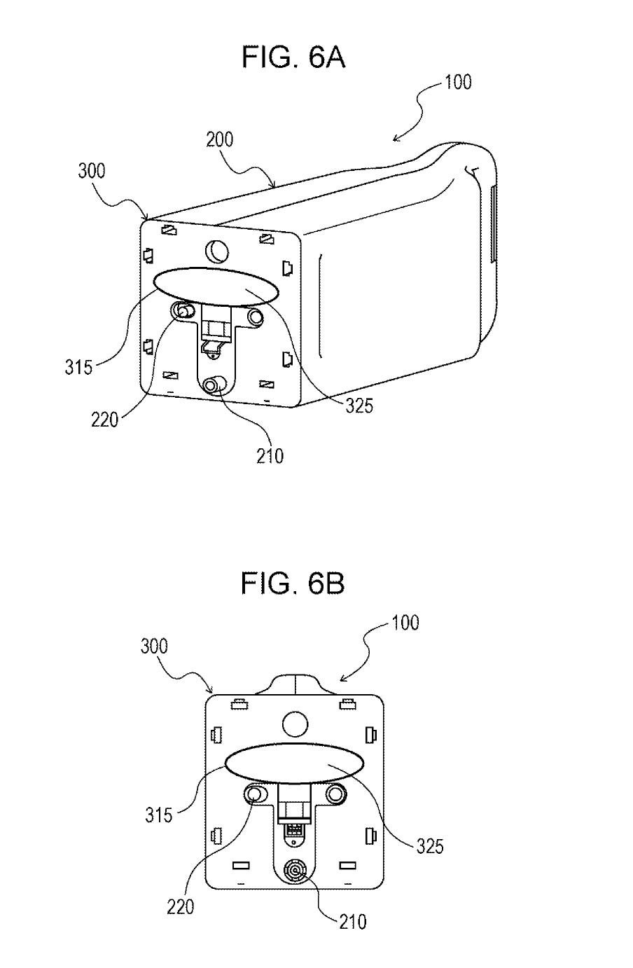

FIGS. 6A and 6B illustrate an ink cartridge 100 according to the second embodiment before the thermal processing step. The ink cartridge 100 includes a liquid container 200 and a covering member 300. The liquid container 200 has, on the front side in the loading direction, a supply port 210 through which ink is guided and an alignment part 220, which aligns the supply port 210 and a needle on the printer. A region 315, which serves as a mis-loading prevention part for preventing mis-loading, is provided on the front side, in the loading direction, of the covering member 300. The region 315 includes an identification plane 325, which is a flat external wall. In the second embodiment, a liquid cartridge having such a flat external wall is provided before forming the mis-loading prevention part 315 in the thermal processing step, which is described below.

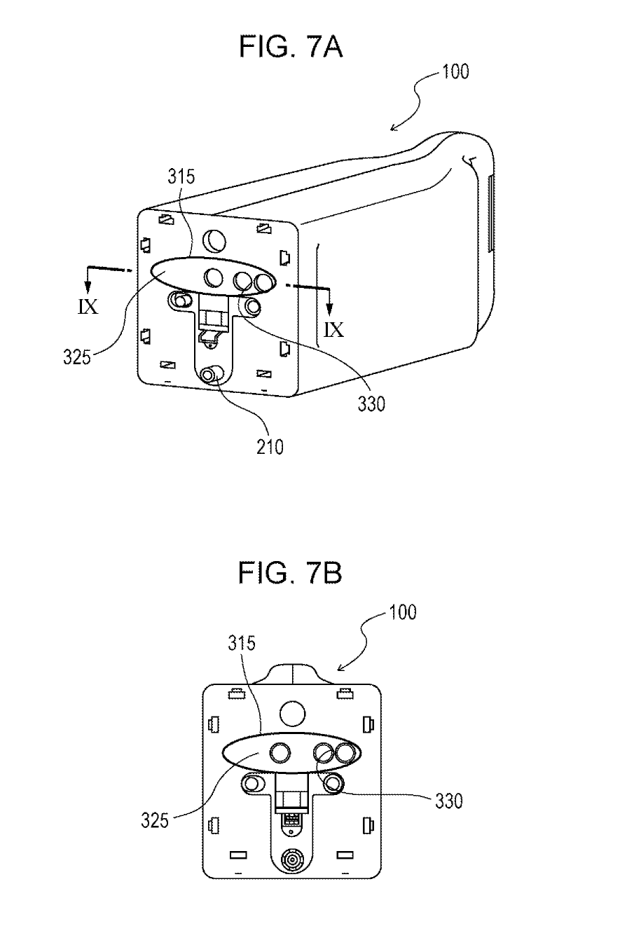

FIGS. 7A and 7B illustrate the ink cartridge 100 after the thermal processing step in the second embodiment. In the thermal processing step, part of the identification plane 325 is thermally melted to form at least one hole (processed part) 330, which serves as the mis-loading prevention part 315. Accordingly, the mis-loading prevention part 315 includes at least one hole 330 formed in the flat external wall (identification plane) 325.

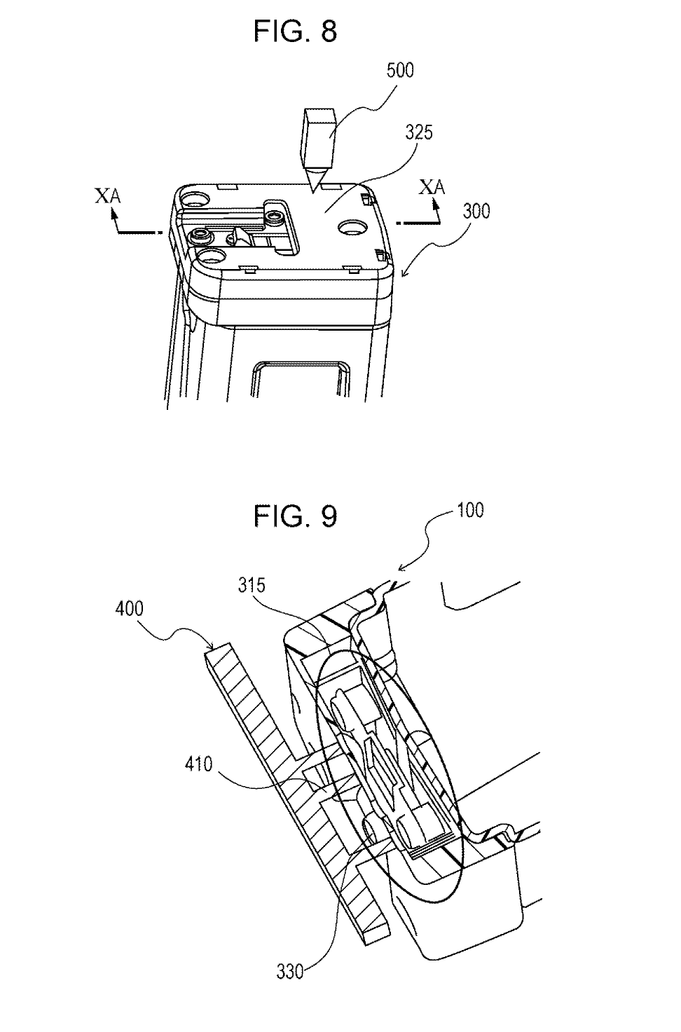

In the second embodiment, the part of the ink cartridge 100 that collides with the identification part of the printer mis-loading is a flat surface. FIG. 8 is a perspective view of thermal processing in the second embodiment. As illustrated in FIG. 8, it is desirable that the identification plane 325 is thermally processed while being held parallel to a horizontal plane so as to uniformly spread the melted material around the processed part during processing. At this time, it is desirable that a processing horn 500 is moved forward and pressed against the identification plane 325 from directly above. Through thermal processing, part of the melted external wall forms a protrusion on the outer circumference of the processed part 330; thus, the identification plane 325 can be processed without generating waste in the process. Since the external wall around the processed part 330 is thickened, the strength of the part surrounding the hole is increased.

FIG. 9 is an enlarged sectional view taken along line IX-IX in FIG. 7A and illustrates the ink cartridge 100 prevented from being loaded by the mis-loading prevention part 315 colliding with identification parts 410 on the printer after the thermal processing step in the second embodiment. The identification parts 410 on the printer are formed in accordance with the type of ink held in the ink cartridge 100 to be loaded. In the case of FIG. 9, the identification parts 410 on the printer and the identification plane 325 of the mis-loading prevention part 315 do not match; therefore, the identification parts 410 and the identification plane 325 collide with each other, preventing the ink cartridge 100 from being loaded. Such collision prevents ink colors from mixing by a joint (not shown) on the printer being inserted into the supply port 210 when the ink cartridge 100 is mis-loaded into the printer.

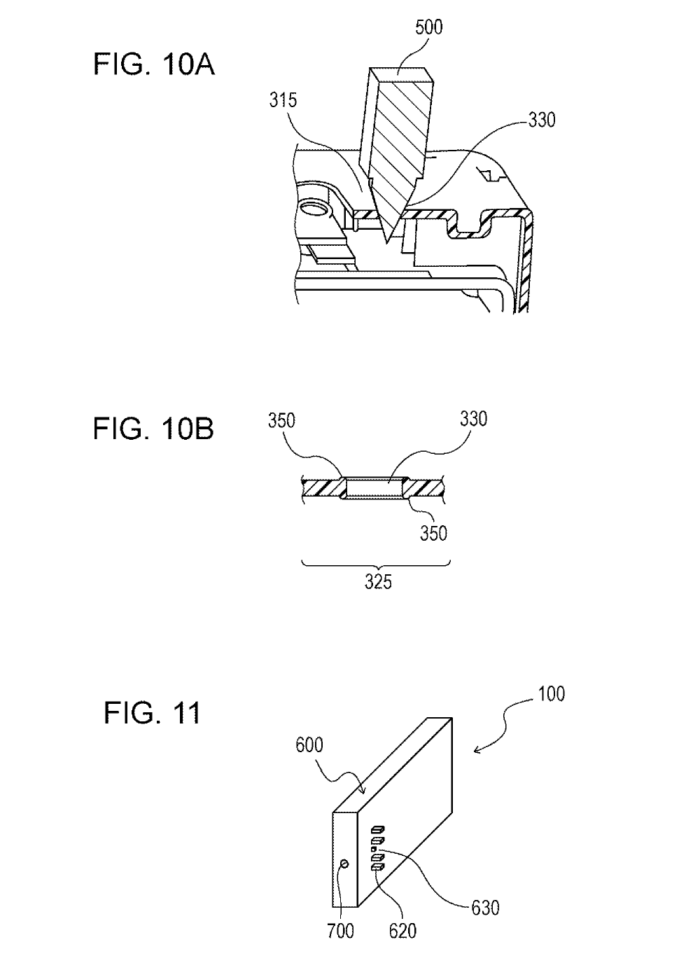

FIG. 10A is a partially enlarged sectional view taken along line XA-XA in FIG. 8 and illustrates the processed part 330 of the mis-loading prevention part 315 during thermal processing in the second embodiment. The processed part 330 is formed by melting and heating the identification plane 325, which serves as the mis-loading prevention part 315, with the heated processing horn 500.

FIG. 10B is an enlarged view of the processed part 330 after the thermal processing illustrated in FIG. 10A and illustrates a protruding outer circumferential part 350 of the processed part 330 formed by thermal processing. The processed part 330 is formed by melting the identification plane 325 by thermal processing. At this time, a protrusion may be formed on the outer circumference of the processed part 330 with the melted part. By forming a protrusion on the outer circumference of the processed part 330, the thickness around the hole 330, which has reduced strength and may become the origin of breaking due to impact caused by mis-loading, increases, and the strength of the surroundings of the hole 330 is increased. In this way, even when the mis-loading prevention part 315 receives an impact during mis-loading, damage is prevented, and reliability is improved.

As illustrated in FIG. 8, it is desirable that the thermal processing method in the second embodiment is employed by moving the processing horn 500 forward from directly above the identification plane 325. In this case, the area required for processing at the mis-loading prevention part 315 can be reduced to an area equivalent to the cross-section of the processing horn 500. As described above, through the thermal processing, a plurality of strong mis-loading prevention parts 315 can be provided in a small area.

In the first and second embodiments, the mis-loading prevention part 315 is disposed on the external wall of the covering member 300 of the ink cartridge 100. Instead, the mis-loading prevention part 315 may be disposed anywhere on the external wall so long as it opposes the identification parts 410 on the printer.

The shape of the mis-loading prevention part 315 of the ink cartridge 100 formed by thermal processing is not limited to that described above, and various modifications are possible. The ink-cartridge attachment part of the printer has an identification part, which are shaped to selectively allow loading of an ink cartridge holding a specific type of ink. In contrast, the mis-loading prevention part of the ink cartridge is shaped such that, when the ink held inside the ink cartridge differs from the ink to be processed, it comes into contract with the identification part and prevents the ink cartridge from being loaded into the printer. Additionally, the mis-loading prevention part may be shaped to match the identification part and allow loading of the ink cartridge into the printer when the ink held in the ink cartridge is the ink to be processed.

A liquid processing apparatus including the above-described liquid cartridge and a liquid consuming apparatus, such as a printer, into which the liquid cartridge is loaded is also included in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-021782 filed Feb. 3, 2011, which is hereby incorporated by reference herein in its entirety.

What is claimed is:

1. A method of producing a liquid cartridge having an identification part corresponding to a type of liquid held inside the liquid cartridge, the method comprising:
preparing the liquid cartridge having a plurality of protrusions protruding from an external wall; and
forming the identification part corresponding to the type of liquid by melting at least one of the protrusions.

2. The method of producing a liquid cartridge according to claim 1, wherein, in the forming step, the at least one protrusion is integrated with the external wall by carrying out thermal processing while pressing the at least one protrusion from the tip of the at least one protrusion toward the external wall with a thermal processing unit while the plurality of protrusions is vertically disposed with respect to the external wall.

3. The method of producing a liquid cartridge according to claim 2, wherein each protrusion is constituted of a hollow member.

4. A method of producing a liquid cartridge having an identification part for selectively loading the liquid cartridge in accordance with a type of liquid held inside the liquid cartridge, the method comprising:
preparing the liquid cartridge having a flat external wall for constituting the identification part; and
forming the identification part corresponding to the type of liquid by forming at least one hole in the external wall by melting the external wall.
